(19) United States
(12) Patent Application Publication
(10) Pub. No.: US 2009/0277093 A1
(43) Pub. Date: Nov. 12, 2009

(54) COMPONENT

(76) Inventor: Helmut Over, Zulpich (DE)

Correspondence Address: COLLARD & ROE, P.C., 1077 NORTHERN BOULEVARD, ROSLYN, NY, 11576, US

(21) Appl. No.: 12/083,144

(22) PCT Filed: Sep. 15, 2006
(86) PCT No.: PCT/DE2006/001642

§ 371 Date: Apr. 4, 2008

Related U.S. Application Data
(60) Provisional application No. 60/809,765, filed on May 31, 2006.

(30) Foreign Application Priority Data
Oct. 8, 2005 (DE) 10 2005 048 282.1
Dec. 13, 2005 (DE) 10 2005 059 996.6
Jan. 3, 2006 (DE) 10 2006 000 818.9
Mar. 22, 2006 (DE) 10 2006 013 574.1
Apr. 28, 2006 (DE) 10 2006 020 455.7

(51) Int. Cl. E06B 3/54

(52) U.S. Cl. 49/400

(57) ABSTRACT

The invention concerns a constituent element, in particular a window or a door, comprising a casement sash and a pane, in particular a glass surface. The invention is characterized in that, the pane has an inner surface and an outer surface. A plane perpendicular to the surfaces intersects a grooved region designed to receive fittings.

The invention relates to a component, in particular to a window or a door, with a window casement and a pane, in particular a glass surface, in which the pane has an inner surface and an outer surface, and a plane perpendicular to these surfaces intersects a grooved region designed to receive fittings.

During the manufacture of doors and window elements, in particular given larger facades with window glass elements and window casements, interest is focused primarily on thermal insulation, since the requirements placed on thermal insulation are becoming continually more stringent. Architectonic problems are here encountered, since the improved thermal insulation leads to smaller transparent window surfaces, and thicker sections with better insulation generally detract from the aesthetic overall impression imparted by the window. In addition, the improved insulation most often achieved by increasing the chamber number in plastic sections results in an increased material outlay and expensive window systems.

The object of the invention is to develop a component that can be further developed into a window system, and combines good insulation indices with a good incidence of light.

In a first aspect of the invention, the object is achieved with a generic component, in which the pane intersects the plane that extends perpendicular to the inner and outer side of the pane and intersects a grooved region designed to receive fittings.

Therefore, the glass comprising the window is mounted in the framework to a depth where at least part of the fitting groove, and preferably the entire fitting groove, is situated behind the pane. When viewing the framework element from the outer surface of the window, the insulation in the framework region of the window is hence first achieved from the outside in via the pane, and subsequently by the window casement. This results in thermal advantages, while simultaneously offering the safety-related advantage of hampering the forcible opening of the window, for example by drilling the fitting groove through the window pane situated at the front on the outer surface of the framework.

In addition, the elevated glass mounting depth offers improved sound insulation, since the increased amount of glass incorporates more mass in the window system.

The specification of the invention repeatedly makes reference to windows. However, statements pertaining to these windows apply equally to both doors or window doors, which also exhibit a window casement and pane.

in addition, the invention makes repeated use of window casements. Statements pertaining to window casements also relate to design variants in which the window casement is rigidly secured with a door/window frame or a coupling section. Understandably, the thermal and aesthetic requirements along with related solutions can be applied equally to a moving window casement and a fixed, glass-enclosed window casement.

Further, the invention repeatedly refers to a pane or glass surface. This primarily relates to glass surfaces. However, these statements also involve opaque panes that can be made of glass or another material. In particular in larger facades, transparent façade elements and opaque façade elements along with fixed, glass-enclosed window casements and moving window casements often alternate. In particular in such façade systems, the component according to the invention can assume the function of a surface that is fixed and glass-enclosed, able to open, transparent or opaque.

Therefore, the grooved region designed to receive fittings is the area in which the fitting groove is situated in a moving window casement with closing spring, regardless of whether a fitting or groove designed for a fitting is present or not.

The component is described in the following based in particular on the example of a plastic window profile with foam expansion and metal reinforcement However, the invention underlying the component is suitable or window systems made of the most varied of materials, with wood PVC, WPC, aluminum and polyamide being examples of especially suitable materials. Mention must here also be made of material combinations, e.g., wood-plastic or wood-aluminum, etc.

The invention permits an optimal glass mounting depth in the window casements, and the negative effects of the edge composite are minimized by the relative positioning of the pane and framework

The window system allows the use of commercially available fittings, and often permits the realization of composite windows.

In PVC windows, the component according the invention makes it possible to lower the material mounting depth to under the usual dimensions, and manufacture windows with Uw values of 1.3; 1.1; 0.8 and even under 0.5 W/m2K using panes having Ug values of 1.3; 1.1; 0.8 and even under 0.5 W/m2K.

One advantageous embodiment provides that a hollow chamber is arranged in the plane between the pane and grooved region designed to receive fittings. This hollow chamber increase the insulation values, and is easy to manufacture for different materials, in particular in the case of plastic window profiles.

Good utilization of the glass mounting depth as an insulation area for the component while simultaneously increasing glass surface inside the framework is achieved in particular if, when viewed perpendicular to the sides of the pane, the ratio of viewing width for the window casement relative to the glass mounting depth measures under 4, preferably under 3, and especially preferred under 2. This yields an especially high glass mounting depth given particularly narrow frames. This feature is also significant to the invention even without the features described previously.

In order to increase the incidence of light, it is further proposed that the window casement be made as wide as possible in the plane of the pane, and elevate the depth of the framework in an extension perpendicular thereto for this purpose. This is achieved by virtue of the fact that, viewed perpendicular to the sides of the pane, the ratio of viewing width for the window casement relative to the window casement depth measures less than 1, preferably less than 0.9. This feature is also significant to the invention even without the features described previously.

An optimal glass mounting depth is achieved by having the component exhibit no hollow chamber between the planes of the inner side and outer side of the pane. As a rule, an edge composite with glass mounting strips and stabilizing and insulating window material has previously been situated between the sides of the pane, up until hollow chambers situated there. The invention is based on the knowledge that the accumulation of material between the planes of the inner and outer side of the pane is not as advantageous as an optimized glass mounting depth. As a result, the casement between the planes of the inner and outer side preferably only exhibits a web and filler material. This filler material is preferably an adhesive. This feature is also significant to the invention even without the features described previously.

The pane can be bonded onto the window casement without a portion of the window casement extending into the area between the inner and outer side of the pane. However, it is advantageous for the window casement in a plane to extend perpendicular to the sides of the pane at least over a portion of the depth of the pane edge, preferably precisely over the depth of the pane edge. For example, a web of the window casement hence extends along the pane edge, thereby encasing the pane. This makes it possible not just to situate the pane on the framework, but position it inside the framework, and fill an adhesive between the pane edge and framework, which holds the pane in the framework. This feature is also significant to the invention without the features described previously.

It is visually and technically advantageous for the window casement to extend in the plane perpendicular to the sides of the pane only up to the plane of the outer surface of the pane. Having it projected over the plane of the outer surface of the pane is technically neither advantageous nor logical.

The invention is also suitable for stepped panes. However, it is advantageous for the pane edge between the sides of the pane to be designed as a flat surface.

Depending on the area of application, it is proposed that the pane exhibit several individual panes of the same size, so as to achieve better insulation indices.

In order to be able to remove a pane from a framework again, it is proposed that the entire adhesive bond between the pane and window casement be established in a U-shaped groove. As a result, the adhesive bond can easily be removed again with commercially available tools, so that a defective pane can be removed from the framework again. The adhesive bond can increase the service life of the pane, improve edge bonding, and prevent vapor diffusion. This feature is also significant to the invention even without the feature described previously.

It is here advantageous for the adhesive bond to be placed only between the planes of the sides of the pane. As a result, the adhesive bond alignment does not extend into the plane of the pane, but perpendicular thereto. This makes it possible to use a tool on the outer surface of the pane to peel the adhesive bond between the pane and framework, moving around the pane. However, in particular safety considerations also make it possible to establish the adhesive bond in a U-shaped groove between the inner surface of the pane and the framework. In such a case, it is advantageous for the window casement to extend in a plane perpendicular to the sides of the pane, at most up to the adhesive bond between the inner surface of the pane and framework.

It is advantageous for the adhesive bond to extend on the face of the glass pane over the entire edge composite.

In one preferred embodiment, a web forms a funnel around the pane for inserting a pane.

In order to make the web easier to deform during insertion of the pane, it is proposed that the web exhibit an incision in the corners of the pane.

A component in which the web is secured to a side of the window casement extending perpendicular to the outer surface of the pane has proven to be especially effective.

In one variant especially suitable for fixed glazing, the web is secured to a mounting element extending perpendicular to the outer surface of the pane.

It is advantageous for this mounting element to exhibit latching means for securing the window casement. The individual features for designing the funnel are also significant to the invention even without the features described previously.

In one advantageous embodiment, a gasket adheres to the pane between the pane and window casement This feature is also significant to the invention even without the features described previously.

It is advantageous for this gasket to adhere between the inner surface of the pane and the window casement. Such a gasket prevents moisture from penetrating into the area between the inner surface of the pane and the window casement.

In order to position this gasket in an especially easy manner, it is proposed that a gasket that interacts positively with the window casement adhere to the pane. This makes it possible to fabricate a window casement, provide a back-cut groove in the window casement, and press a gasket into this groove. This gasket preferably has an adhesive surface facing away from the groove, which initially is covered by a protective film.

Following insertion of the pane, the window casement preferably extends in an L around an edge of the pane, and covers a portion of the inner surface of the pane, and at least a portion of the pane edge.

As a result, the edge composite of the pane and portion of the framework covering the inner surface of the pane are visible, in particular with the window open. Therefore, it is proposed that the component exhibit a cover on the outer surface of the pane. This feature is also significant to the invention even without the features described previously.

One simple embodiment variant proposes that the variant is a film.

In an even simpler embodiment, the cover is formed by a coloration. The coloration is usually black, and obscures the view of the edge area of the pane and translucent edge areas. A partial coloration is usually enough to satisfy the aesthetic requirements and protect against UV radiation, especially on the edge area, for example, hatched coloration or spotted coloration, which is know in particular for adhesively bonded automobile panes.

One special embodiment variant proposes that the cover be L-shaped in a section through the planes of the pane.

In order to allow a gasket for a door or window frame to abut the pane directly, it is proposed that the cover only envelop a portion of the glass mounting depth. As a result, a portion of the glass mounting depth remains uncovered for the direct placement of a gasket on the outer surface of the pane.

In a cover extending around the pane, it is proposed that the cover can shift perpendicularly to the sides of the pane, thereby allowing the use of covering means for panes of varying thickness. To this end, it is also proposed that the cover and window casement interact by way of a spring-groove system.

In particular in cases where the cover is a part of the window casement, it is proposed that the cover be adhesively bonded with the pane.

However, the edge composite can also be fabricated out of a special UV-light resistant material. In this case, the cover can be omitted without any problem.

In order to be able to use essentially the same window casement for panes of varying thickness, it is proposed that the window casement exhibit an insertion strip situated opposite the inner surface of the pane. Such an insertion strip can essentially be placed between the window casement and pane, so as to provide an equalizing means on the inner surface of the pane in the case of thinner panes that thicken the frame to reflect the reduced thickness.

It is advantageous for the insertion strip to be latched and preferably hinged. Latching permits a rapid fastening, and in particular the combination of hinging and latching results in a reliable attachment. The features of the insertion strip are also significant to the invention even without the features specified previously.

A plurality of variations for a window casement becomes possible if the window casement exhibits an additional mounting device for another pane. For example, a replaceable pane can be provided in the additional mounting device, and replaced depending on the situation. However, the additional pane can also increase the insulation indices of the window as a winter pane and be removed in the summer. This feature is also significant to the invention even without the features specified previously.

It is advantageous that the additional pane can rotate around an axis relative to the window casement. This makes it possible to provide the additional pane with a special coating for example, which allows thermal radiation to penetrate into a home during winter. Rotating the pane around the axis causes the side of the pane formerly lying on the inner surface to move to the outer surface after the pane has been turned. As a result, the pane can be rotated during use in the summer to reflect back incoming heating rays.

In one structurally advantageous embodiment, the axis is horizontal. This makes it possible to rotate the pane around a horizontal axis, so that another function of the pane can be utilized after the pane has been turned.

In order to achieve functions like a metal coating for a pane, or special radiation reflection or transmittance, it is proposed that the additional pane exhibit a coated glass. Different coatings can yield the most varied of pane functions, which produce varying effects, depending on whether the coating is arranged on the outer surface of the pane or on its inner surface.

The component can be further optimized by having the component exhibit a door or window frame against which the pane abuts. The door or window frame can here either join the window casement with a fixed component, or act as the coupling element, for example given coupling points between window elements.

In order to keep the distance between the door or window frame as small as possible, it is proposed that the door or window frame exhibit a closure piece, whose side allocated to the window casement has a distance of about 4 mm to the window casement. This especially narrow distance between the door or window frame and window casement reduces the thermal passage in the narrow gap between the door or window frame and window casement. A distance of 4 mm is advantageous. However, the distances can be somewhat larger, and in particular shorter distances are suitable for reducing thermal transfer at this location. This feature is also significant to the invention even without the features specified previously.

The same objective is achieved by virtue of the fact that the window casement exhibits a plane opposite the door or window frame with a grooved region designed to receive fittings, wherein the distance between the plane and door or window frame opposite the grooved fitting region exhibits a rebate depth of about 12 mm in a first area, and the distance between the plane of the window casement and door or window frame exhibits a rebate depth of less than 12 mm, preferably less than 6 mm, and particularly preferred less than about 4 mm in a second area. This reduces the distance between the door and window frame and window casement to under 4 mm, at least in one area. This feature is also significant to the invention even without the features specified previously.

In order to provide enough space for inserting a closure piece on the one hand, and keeping the distance between the window casement and door or window frame as narrow as possible in the area of the pane, it is proposed that the second area aligned perpendicular to the sides of the pane be longer than 30 mm.

The described configuration makes it possible to arrange a gasket that buts the pane in the area where the door or window frame and pane contact each other. This gasket can lie between the planes of the inner surface and outer surface of the pane between the door or window frame and the face of the pane, so as to form a seal between the door or window frame and window casement. However, the gasket between the door or window framed and window casement can also lie between the outer surface of the pane and the door or window frame. In this case, a gasket that abuts the pane is arranged in the area where the door or window frame and pane contact each other. This gasket can be held in a groove in the door or window frame. However, it can also be adhesively bonded to the pane and interact with the door or window frame to form a seal.

In one embodiment variant, a gasket arranged between the outer surface of the pane and the door or window frame is adhesively bonded to the outer surface of the pane, thereby assuming the function of a cover. As a result, for example, the gasket can protect the edge composite of the pane against exposure to UV radiation, while simultaneously forming a seal between the outer surface of the pane and the door or window frame.

In one preferred embodiment variant, the door or window frame covers more than 24 mm, preferably more than 30 mm, of the glass mounting depth. As a result, the door or window frame assumes an insulation function in addition to the window casement. The door or window frame and window casement preferably envelop the glass mounting depth in the form of a C.

In order to enable the best possible incidence of light and simultaneously provide optimal insulation properties for the window, it is proposed that the door or window frame cover a portion of the outer surface of the window casement, and that the ratio of maximum width of the door or window frame to the maximum depth of the door or window frame measure 1 or less. As a result, the door or window frame has as narrow a design as possible when viewing the window from above, and its insulation properties result primarily from the structural depth, which does not detract from the incidence of light.

Depending on the area of application, the door or window frame or window casement can cover a larger area of the window. However, it is advantageous if the window casement and door or window frame cover about the same amount of the pane.

A visual appearance approximating the conventional design of a window is achieved by virtue of the fact that the door or window frame is a single piece opposite the window casement, and exhibits a groove on the surface facing away from the pane. Although this groove suggests a separation between the door or window frame and window casement, it is actually no discernible from the outer surface of the window.

Therefore, described component can be designed in such a way that, when several windows are coupled, the width is twice the frame, so that the width of the coupling is narrower than the width of two casements plus the width of a window post.

Also proposed with the described component is a casement glazing that does without glass holding strips. In comparison to conventional window casements, the window casement can be designed to be less stable, since the glass pane ensures the stability of the casement. While the casement previously supported the glass pane, the pane now supports the casement. This is preferably achieved by virtue of the fact that the glass pane is adhesively bonded with the window casement.

In particular when using a plastic hollow chamber profile, the component design makes it possible to arrange a metal reinforcing strip in a hollow chamber, and either injection foam into the hollow chamber, or introduced foamed elements shaped like the hollow chamber into the hollow chamber, and adhesively bond them there, if needed. The metal bracing to be provided in particular in the door or window frame is preferably a perforated steel profile, which can have staggered longitudinal holes, the extension of which lies in the window plane.

One simple way to drain off water is to place a foamed strip in a hollow chamber profile, which forms a channel between the hollow chamber and foamed strip. Boreholes in this hollow space allow water to get into the channel, flow along this channel, and exit the channel again at a location marked by another borehole.

In addition, the component makes it simple to provide an outer cladding, e.g., made of aluminum, to laminate the outer appearance in particular of a wood or plastic window.

Further, the component enables the fabrication of facades with fixed glazing and casement glazing, in which the fixed glazing and casement glazing lie in one plane.

A long service life is achieved for the component by virtue of the fact that the outer surfaces of the component are easy to clean. Also advantageous are the self-cleaning characteristics of the window sections and glass pane, for example those achieved by way of the lotus effect. Once the service life of the component is over, it can be broken down into its constituent parts, which all can be recycled.

The following table shows the calculated results at window dimensions of 1230 mm×1480 mm and a viewing width of 114 mm.

Table of calculated results at window dimensions of 1230 mm × 1480 mm and a viewing width of 114 mm

| | | Viewing | | Edge | Framework | | Window value | | |
|---|---|---|---|---|---|---|---|---|---|
| | | width | Glazing | composite | cross | Window value | [5] | More incidence | |
| | Installed | frame/glass | [1] | polyamide | section | [4] | Uw value | of light | Less PVC |
| | frame | mounting | Ug value | 25% GF | [3] | Uw value | W/m2K | 100 = 1.2542 | utilization |
| | depth | depth | W/m2K | [2] | Uf value | W/m2K | calculated, | m2 · bci | 100% = 2.268 mm² |
| | approx. | approx. | calculated, | Psi value W/mK | W/m2K | calculated, | estimated | difference | difference |
| No. | mm | mm | desired | calculated | calculated | actual | measured value | m² % | mm² % |
| | PVC | | | | | | | | |
| 1 | 100 | 80/39 | 1.284 | 0.02043 | 0.917 | 1.255 | 1.20 | 1.412 + 13% | 1903 − 16% |
| 2 | 100 | 80/39 | 1.098 | 0.01736 | 0.827 | 1.083 | 1.03 | 1.412 + 13% | 1903 − 16% |
| 3 | 100 | 80/39 | 0.978 | 0.01751 | 0.827 | 0.99 | 0.93 | 1.412 + 13% | 1903 − 16% |
| 4 | 100 | 80/39 | 0.700 | 0.01927 | 0.769 | 0.767 | 0.71 | 1.412 + 13% | 1831 − 19% |
| 5 | 100 | 80/39 | 0.516 | 0.01883 | 0.769 | 0.622 | 0.57 | 1.412 + 13% | 1831 − 19% |
| 6 | 100 | 90/49 | 0.516 | 0.01540 | 0.707 | 0.604 | 0.55 | 1.365 + 9% | 1946 − 15% |
| 7 | 100 | *110/69 | 0.516 | 0.01083 | 0.695 | 0.599 | 0.54 | 1.272 + 1.5% | 2008 − 11% |
| 8 | 100 | 100/59 | 0.516 | 0.01261 | 0.661 | 0.588 | 0.53 | 1.318 + 5.2% | 2061 − 9% |
| 9 | 100 | 110/69 | 0.516 | 0.01031 | 0.626 | 0.575 | 0.52 | 1.272 + 1.5% | 2176 − 4% |
| 10 | 100 | 120/79 | 0.516 | 0.00848 | 0.597 | 0.563 | 0.51 | 1.227 − 2% | 2291 + 1% |
| 11 | 110 | 80/39 | 0.516 | 0.01944 | 0.721 | 0.613 | 0.56 | 1.412 + 13% | 1895 − 16% |
| 12 | 120 | 80/39 | 0.516 | 0.01981 | 0.694 | 0.608 | 0.55 | 1.412 + 13% | 1959 − 14% |
| 13 | 120 | | 0.516 | 0.00977 | 0.524 | 0.543 | 0.49 | 1.227 − 2% | 2419 + 7% |
| 14 | 135 | 120/79 | 0.466 | 0.01073 | 0.493 | 0.501 | 0.45 | 1.227 − 2% | 2510 + 11% |
| | Wood | | | | | | | | |
| 15 | 100 | 80/32 | 0.519 | 0.01769 | 0.895 | 0.650 | 0.60 | 1.412 + 13% | |
| 16 | 100 | 120/72 | 0.519 | 0.00631 | 0.754 | 0.611 | 0.55 | 1.227 − 2% | |
| | Alum Polyamide | | | | | | | | |
| 17 | 100 | 80/32 | 0.519 | 0.02200 | 0.946 | 0.672 | 0.62 | 1.412 + 13% | |
| 18 | 100 | 100/52 | 0.519 | 0.01533 | 0.783 | 0.631 | 0.58 | 1.318 + 5.2% | |

*Framework view from outside 80 mm, overall inside view 110 mm.
The values in columns 1, 2, 3, 4 were determined with WinIso 2D Professional and WinIso3D from Sommerinformatik. 1 = Ug per prEN 10077-2. 2 = Psi per prEN 10077-2. 3 = Uf per prEN 10077-2. 4 = Uw per DIN EN ISO 10077-1

In one exemplary embodiment, the viewing width could be reduced to 80 mm in a standard window with a viewing width of 115 mm (framework and casement). This increased the incidence of light by 13%, and yielded a 16% reduction in required PVC material. The achieved Uw values measured 1.2 WS/m²K to 0.5 W/m²K in the described standard window with 1230 mm×1480 mm.

A variety of exemplary embodiments will be described in greater detail below based on the drawing. Shown on:

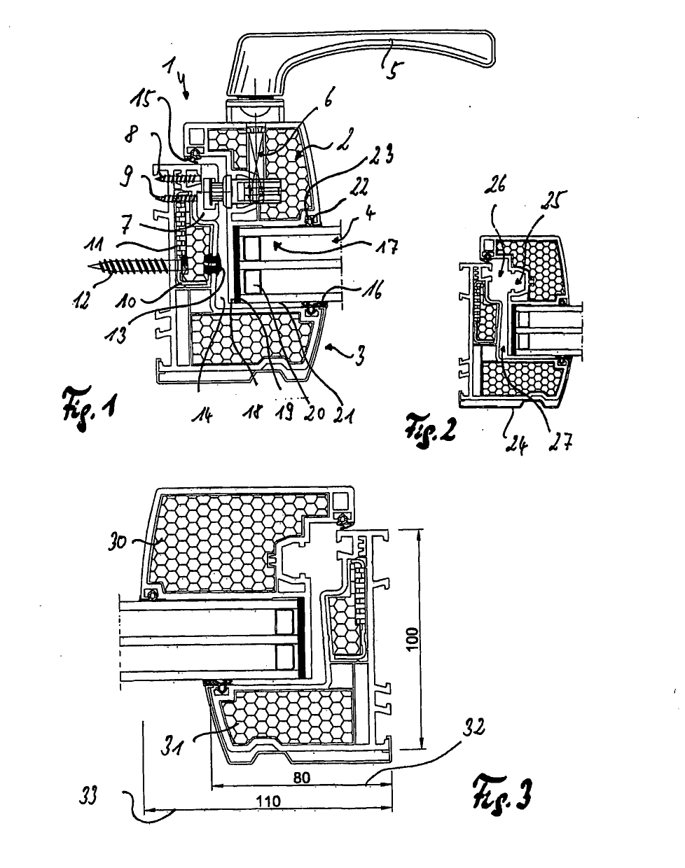

FIG. 1 is a section depicting the area of a window through the door or window frame and window casement, with closure piece and handle.

FIG. 2 is a reduced section through the window shown on FIG. 1 without closure device;

FIG. 3 is a section through an area of a door, again without closure device;

FIG. 4 is a section through an area of the window without sheet metal sheathing in the design of a casement window

FIG. 5 is a section according to FIG. 4 with sections made of various materials;

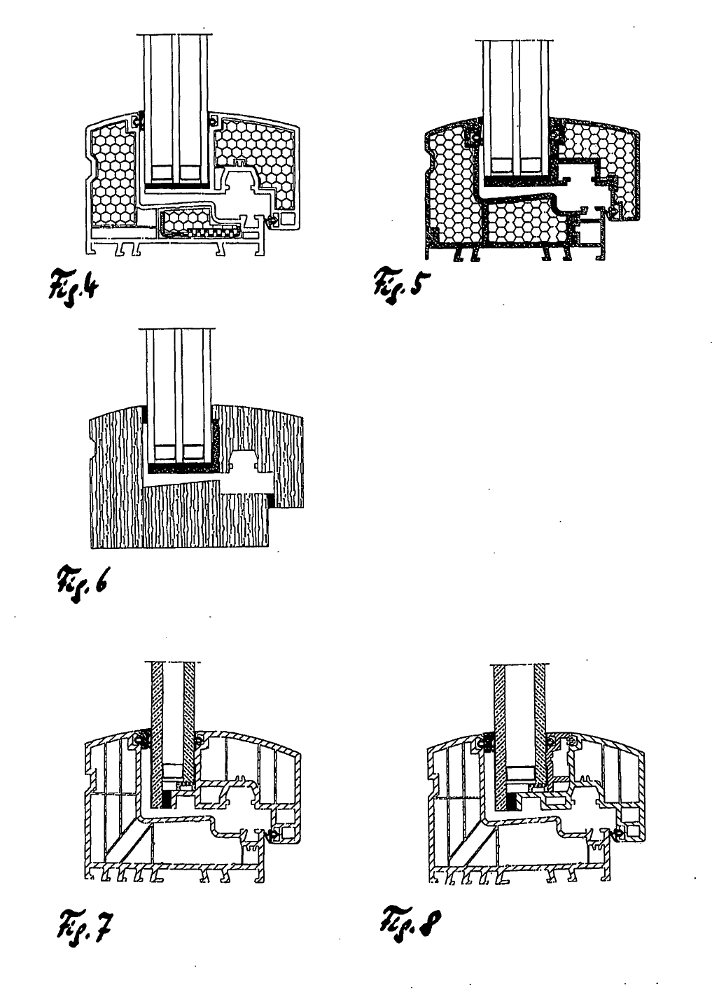

FIG. 6 is a section according to FIG. 4 with wood door or window frames and window casements;

FIG. 7 is a section through an area of a window with stepped pane.

FIG. 8 is a section through an area of the window with stepped pane and insertion strip between the inner surface of the pane and the window casement;

FIG. 9 is a section through an area of a window with a cover that can be shifted in a groove;

FIG. 10 is a section according to FIG. 9 with a thicker pane and a thinner gasket between the outer surface of the pane and the door or window frame;

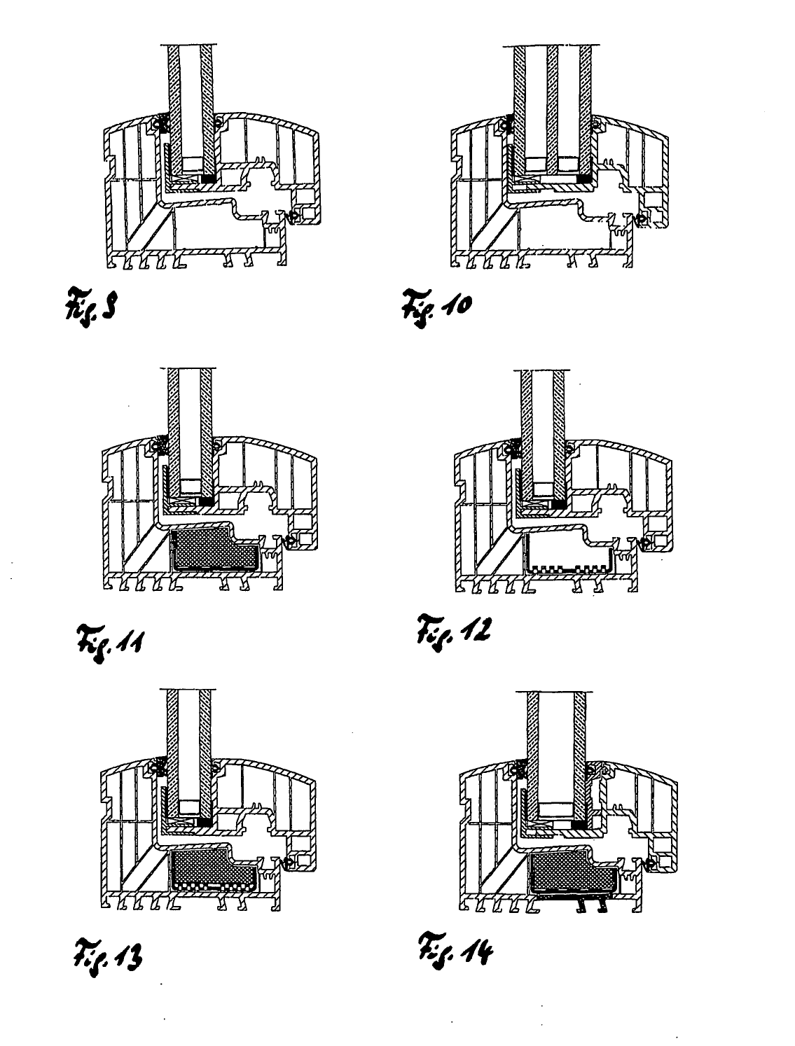

FIG. 11 is a section according to FIG. 9 with a U-shaped reinforcing strip in the door or window frame, as well as a foamed strip adhesively bonded therein;

FIG. 12 is a section according to FIG. 11 with a reinforcing strip that exhibits holes in the area between the inner surface and outer surface of the window;

FIG. 13 is a section according to FIG. 12, in which a strip made of foamed insulation material is adhesively bonded in the reinforcing strip;

FIG. 14 is a section according to FIG. 11, in which the door or window frame exhibits an insertion piece with poorer insulation properties;

FIG. 15 is a section through an area of a window, in which the outer surface of a thinner pane exhibits a film cover in the mounting depth area;

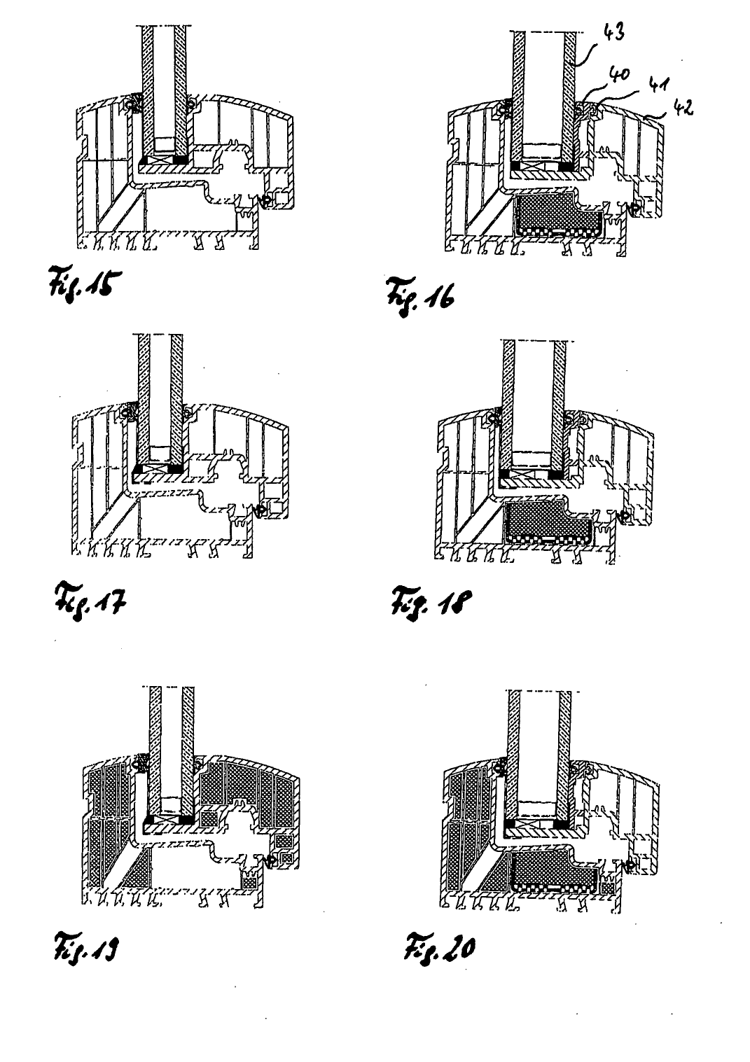

FIG. 16 is a section according to FIG. 15 with a thicker pane and an insertion strip between the inner surface of the pane and the window encasement;

FIG. 17 is a section according to FIG. 15 with latched cover;

FIG. 18 is a section according to FIG. 16 with latched cover;

FIG. 19 is a section according to FIG. 17 with foamed chambers in the plastic hollow chamber profile, except for the water discharge chamber;

FIG. 20 is a section according to FIG. 18 with foamed chambers;

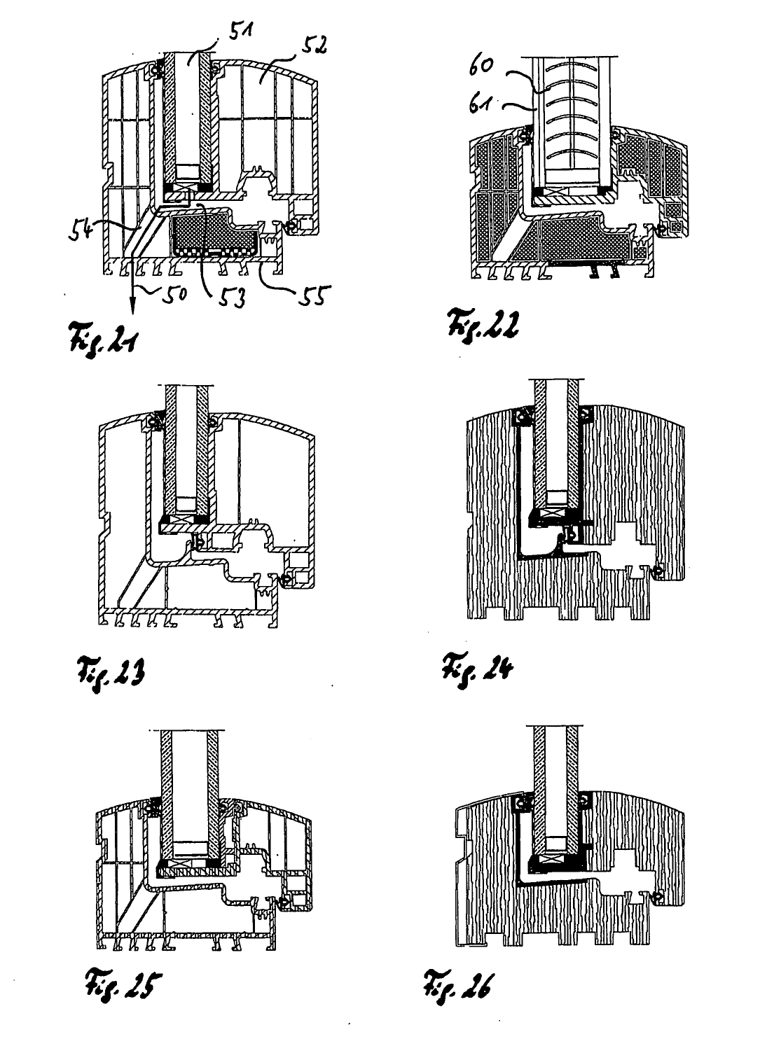

FIG. 21 is a section through an area of a window with especially large glass mounting depth and penciled in water discharge path;

FIG. 22 is a section through an area of a window with insulation web in the framework and shading device inside the pane;

FIG. 23 is a section through a middle sealing window;

FIG. 24 is a section through the window according to FIG. 23 with wood window casement and door or window frame, as well as strips consisting of a mixed plastic and wood material;

FIG. 25 is a section through an area of a window consisting of a mixed plastic and wood material;

FIG. 26 is a section through an area of a window with wood door or window frame and metal cover;

FIG. 27 is a section through a door or window frame with an insert made of special plastic;

FIG. 28 is a section through a window casement with an attachment section made of special plastic;

FIG. 29 is a section through a window casement with an alternative attachment section made of special plastic;

FIG. 30 is a section through an area of a window with a mounting section made of a mixed plastic and wood material;

FIG. 31 is a section through an area of a window with a mount for another pane;

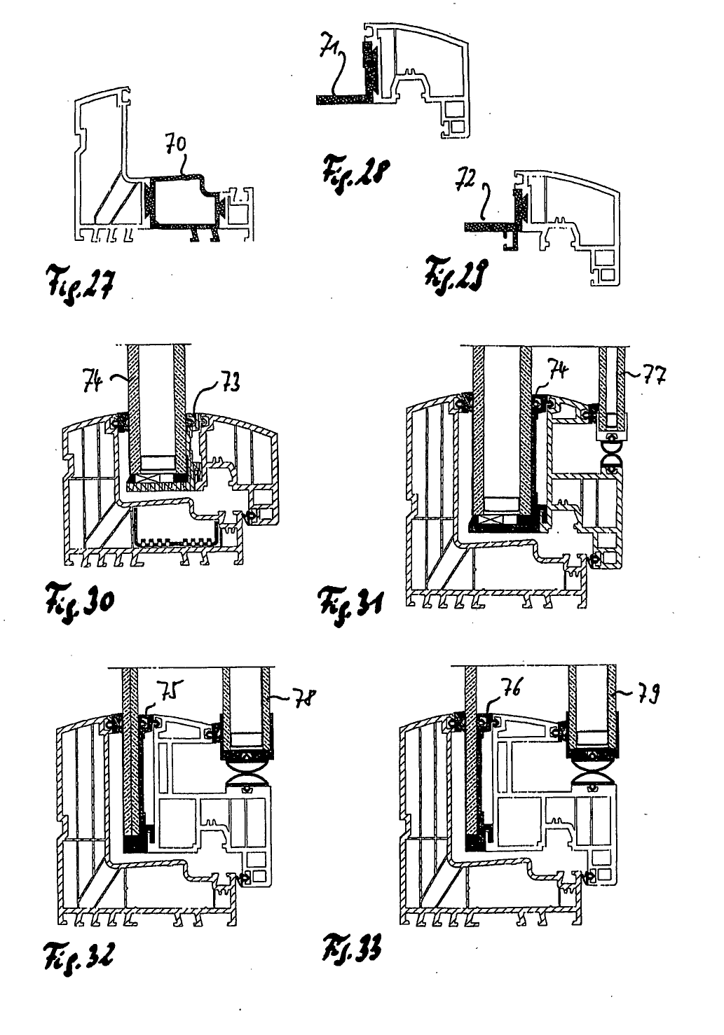

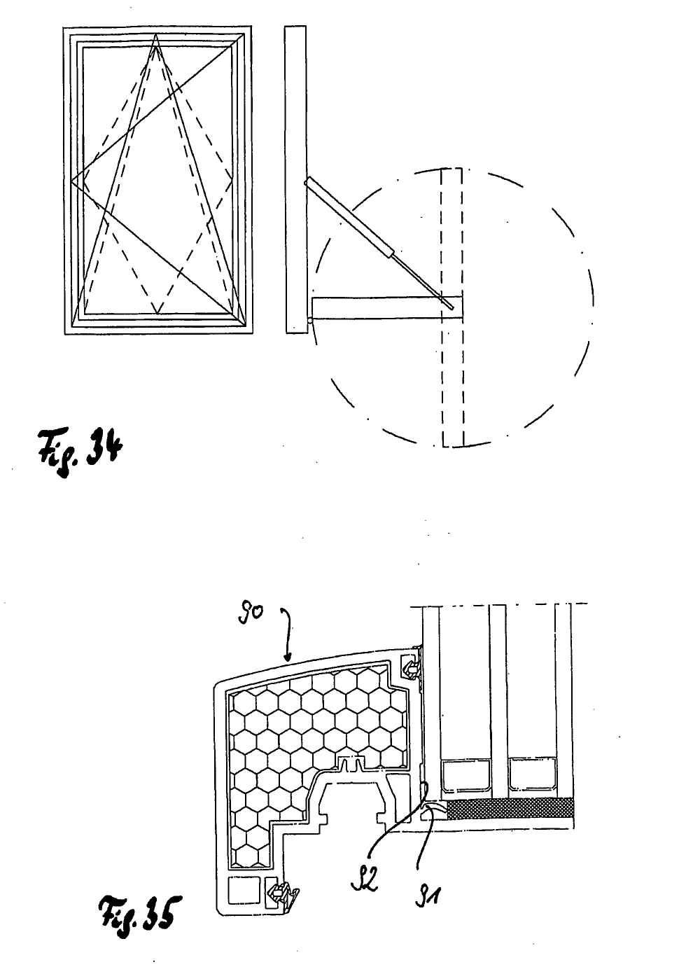

FIG. 32 is a section through an area of a window with a first mount for a thin pane and another mount for a thicker pane;

FIG. 33 is a section through an area of a window according to FIG. 32 with a mount for an even thinner pane;

FIG. 34 is a schematic depiction for opening and moving the other pane;

FIG. 35 is a section through an area of a window with a web, which forms a funnel for incorporating a pane;

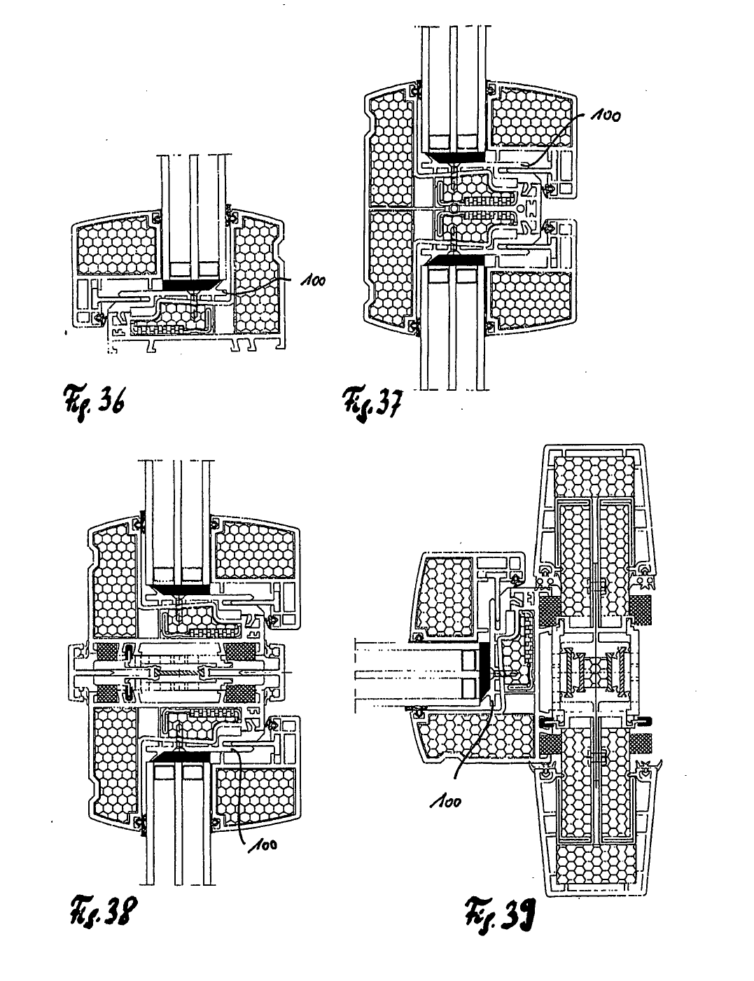

FIG. 36 is a section through an area of a window with fixed, glazed pane;

FIG. 37 is a section through a component with fixed glazing for use as a window post or sliding bolt;

FIG. 38 is a section through a component with two door or window frames, which are joined by means of a coupling;

FIG. 39 is a section through a fixed glazing, with a pane held in the frame and a coupling;

FIG. 40 is a section through a component with a casement and loose setting post;

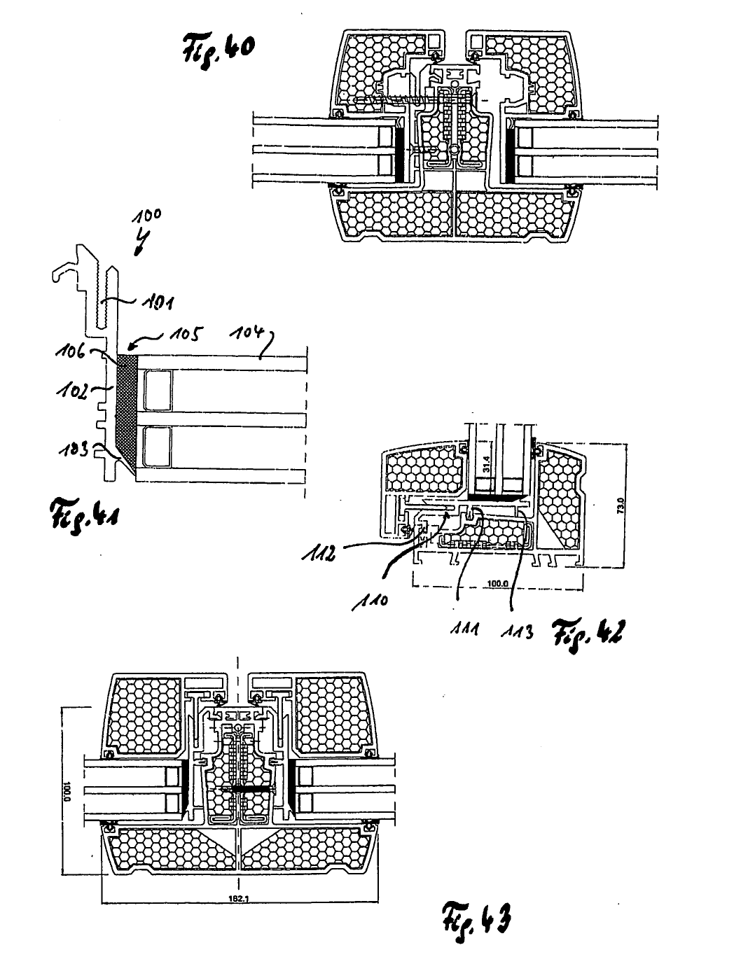

FIG. 41 is an alternative embodiment for an insertion element with a funnel for incorporating a pane;

FIG. 42 is a section through a fixed glazing with latched-in insertion part;

FIG. 43 is a section through a window post with two latched-in insertion parts;

FIG. 44 is a section through a part of a window with a trailing gasket between the door or window frame and window casement;

FIG. 45 is a section corresponding to FIG. 44 on an especially narrow framework;

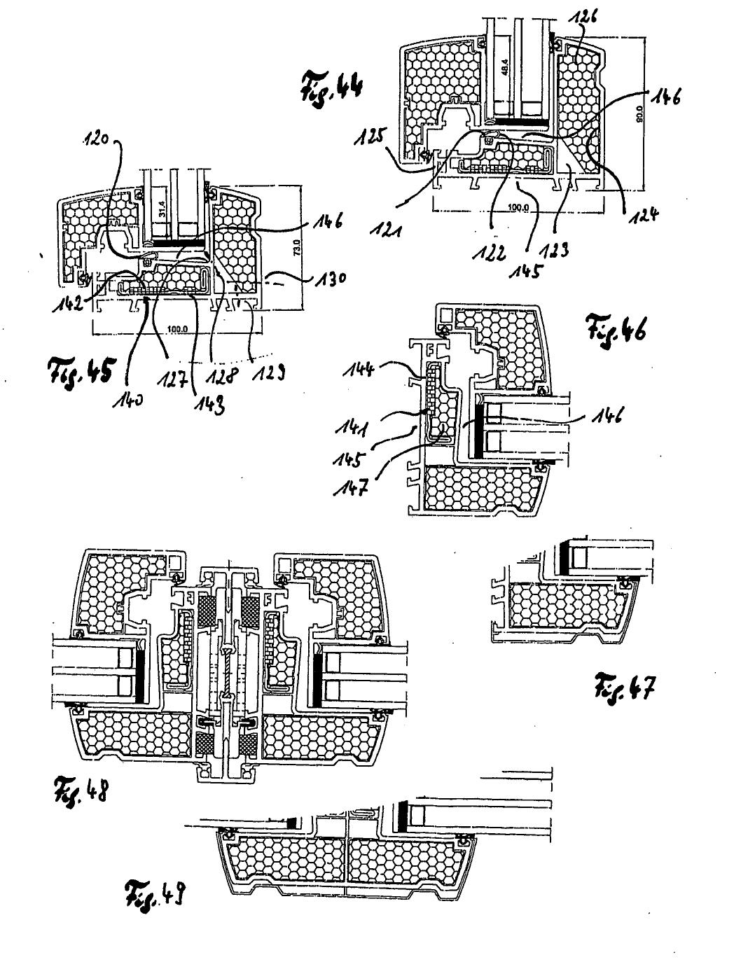

FIG. 46 is a section through a component with framework and casement;

FIG. 47 is a section through a partial area of the component with metal cover shown on FIG. 46;

FIG. 48 is a section through a component with two openable casements and two frameworks joined via a coupling;

FIG. 49 is a section through a partial area of the component with metal cover shown on FIG. 48;

FIG. 50 is a section through a component with fixed setting post and two window casements;

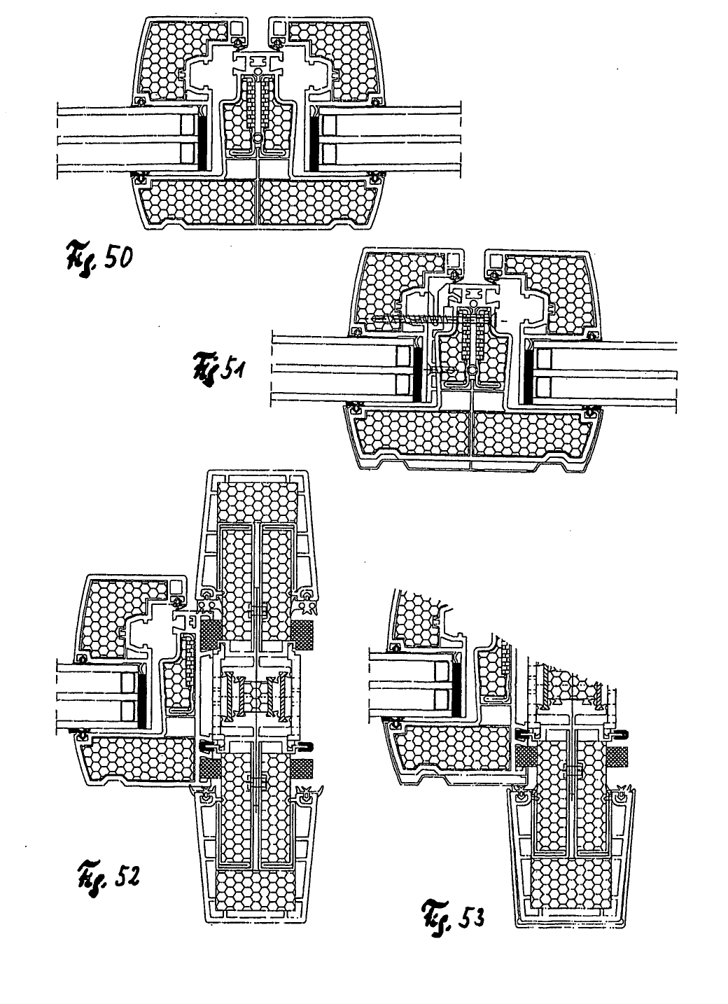

FIG. 51 is a section through a component according to FIG. 50 with loose setting post and metal cover;

FIG. 52 is a section through a coupling section with framework and casement;

FIG. 53 is a section through the section shown on FIG. 52 with metal cover;

FIG. 54 is a section through a fixed glazing with window post and sliding bolts;

FIG. 55 is a section through a fixed glazing with a first coupling and

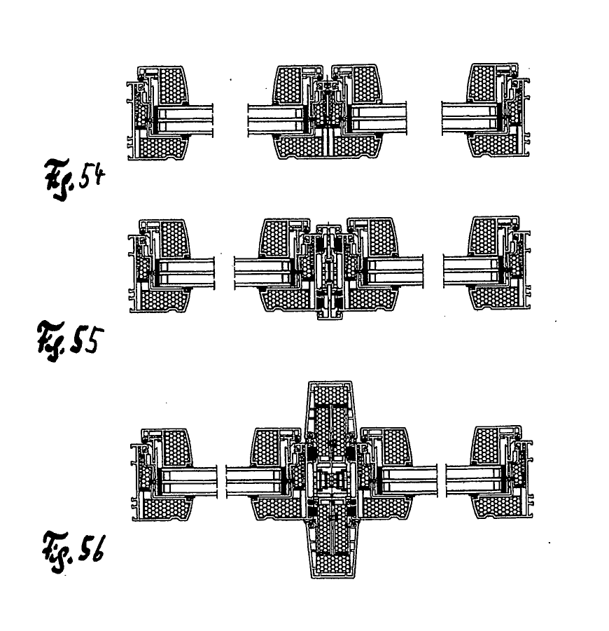

FIG. 56 is a section through a fixed glazing with a second coupling;

FIG. 57 is a section through a window casement with window post and sliding bolts;

FIG. 58 is a section through a window casement with loose setting post;

FIG. 59 is a section through a window casement with a first coupling;

FIG. 60 is a section through a window casement with a second coupling;

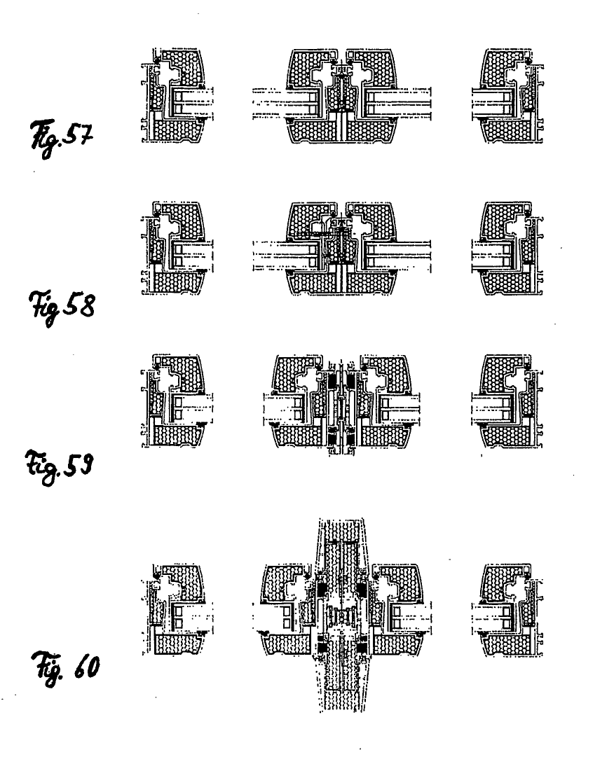

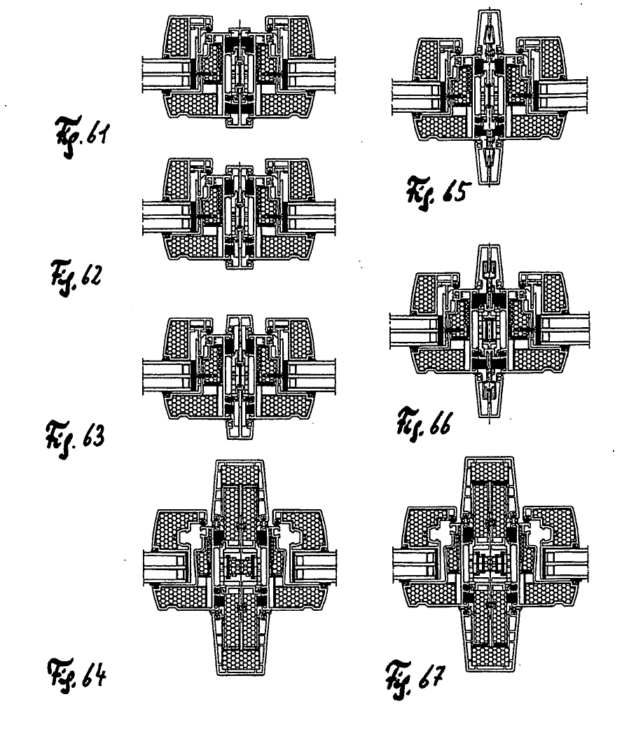

FIG. 61 to FIG. 67 is a plurality of sections through various coupling profiles, and

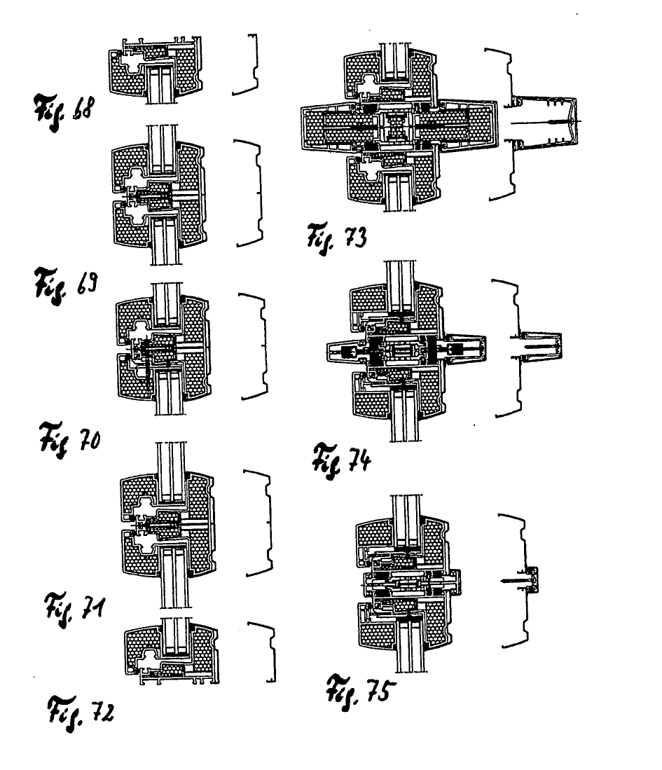

FIG. 68 to FIG. 75 is a plurality of coupling profiles with corresponding metal covers.

The plurality of figures shows the expert different areas of application and embodiment variants for various components.

The component shown on FIG. 1 essentially consists of a window casement 2, a door or window frame 3 and a pane 4. The window casement 2 exhibits a handle 5, which works by way of a mechanical closure 6 in conjunction with a closure piece 7 arranged in the door or window frame 3. This closure piece 7 is secured to the door or window frame by means of screws 8 and 9.

The screw 9 here passes through a reinforcing strip 10, which exhibits staggered longitudinal holes 11 running in the plane of the pane between the outer surface and outer surface of the window. Another screw 12 runs through this reinforcing strip, and can be used, for example, to secure the door or window frame in brickwork. A borehole in the door or window frame profile provides access to the screw is provided, and is subsequently sealed via a stopper 13.

A slightly conical gap 14 having a gap width of 0 to about 4 mm is situated between the door or window frame and window casement. This gap width of 0 to about 4 mm extends continuously over the entire width in which the door or window frame and window casement lie opposite each other. Therefore, the gap 14 extending perpendicular to the plane of the pane is situated between the abutment areas extending in the plane of the pane between the door or window frame and window casement or door or window frame and pane. These abutment areas have gaskets 15 and 16.

The screw 4 lies in an L-shaped abutment area 17 in the framework 2. For this purpose, the framework 2 has a web 18 that extends perpendicular to the plane of the pane, and has a length roughly corresponding to the pane thickness. Provided between the web 18 and face of the pane 4 is a U-shaped groove, which is filled with an adhesive compound 19.

The edge composite of the pane 4 is exposed to daylight UV radiation with the window open. In order to prevent UV radiation from destroying the edge composite 20, either a UV radiation-resistant edge composite is used, or the outer surface 21 of the pane 4 is provided with a coloration in the area of the edge composite, in particular shaded black.

A back-cut 23 in the window casement 2 on the inner surface of the pane incorporates a latched-in gasket element 22 that abuts the pane 4. When the pane is placed in the framework 2, a protective film is removed from the gasket latched into the casement, so as to achieve a good seal between the pane 4 and window casement 2.

As shown on FIG. 2, in particular the outer surface of the component can also be protected by a metal sheathing 24. In addition, FIG. 2 clearly shows a grooved region designed to receive fittings 25, in which fittings can be provided, for example. An area 26 in which a folding height of about 12 mm exists between the casement and frame is provided in this grooved fitting region. The folding height only measures 0 to about 4 mm in a second area 27 that extends essentially between the pane and door or window frame perpendicular to the plane of the pane.

FIG. 3 shows a special embodiment of a component provided especially for doors. In this case, the inner surface is provided with an especially wide window casement profile 30 lying opposite the doorframe profile 31. While the viewing width 32 of the window casement profile measures about 80 mm, the viewing width 33 of the window casement profile measures about 110 mm [sic]. This yields especially good insulation in the framework area, and provides abundant construction space for fittings.

FIG. 4 to 6 show the use of varying materials for manufacturing the component. Reference will here be made in particular to the use of steel girders, especially with holes for increasing stability, foamed areas or inserted, foamed elements. Other figures show the provision of chambers in plastic hollow chamber profiles, the use of metal materials, plastic, special plastics with low thermal conductivity, composite materials made of plastic and wood, along with special material mixtures with plastic and wood, up to and including known wood windows.

FIGS. 7 and 8 show the adjustment of the component so a stepped pane.

FIG. 9 to 14 show the use of a cover guided in a groove and spring system for different casement and framework profile variants. Other covers are described on FIG. 15 to 20. While a thin pane is present on FIGS. 15, 17 and 19, the inner surface of which abuts the window casement via the gasket, FIGS. 16, 18 and 20 show an insertion element 40 used to compensate for thickness, which is located between the framework and inner surface of the pane. This insertion element 40 can be made of various materials, and is joined with the remaining framework via a latching connection 41. The latching connection 41 can also be made out of a sealing plastic material. In this case, the gasket between the framework profile 42 or the individual piece 40 and the inner surface of the pane 43 can be omitted.

FIG. 21 to 26 show additional embodiment variants. The FIG. 21 here shows the discharge path 50 from the abutment area between the pane 51 and window casement 52 via the folding area 53 in a channel 54 in the door or window frame up to the lower side 55 of the door or window frame profile.

FIG. 22 shows the presence of lamellae 60 in a pane 61.

FIG. 27 to 29 show profile sections that exhibit inserts 70, 71 and 72 made of a poorly thermally conductive special plastic. The insertion part 70 reduces the thermal transfer in the door or window frame profile between the inner surface and outer surface, while the insertion piece 71 reduces the thermal transfer on the window casement, and the insertion piece 72 is specially designed for middle sealing windows.

FIG. 30 shows a special insertion piece 73, for example, which consists of plastic and wood materials, and is hinged in the window casement, carrying the pane 74. FIG. 31 to 33 show additional embodiments of such intermediate profiles 74, 75 and 76. In addition, FIG. 31 to 33 show how the component can interact with another pane 77, 78, 79. A mechanism allows the additional panes 77, 78 and 79 to rotate, so that the inner surface of the panes can also be used as the outer surface. FIG. 34 shows the mechanism for such a rotatable attachment for an additional pane.

The profile 90 shown on FIG. 35 is provided with a continuous web 91, which abuts a surface 92 extending parallel to the plane of the pane, and forms a funnel for inserting the pane as a continuous web band.

FIGS. 36, 37, 38, 39 and 40 show an insertion element 100 that is magnified on FIG. 41. This insertion element has a latching area 101, to which a framework section can be secured. A diagonally projecting element 103 that forms a funnel for incorporating a pane 104 is provided on a web 102, which extends perpendicular to the plane of the pane in the built-in state. Since the element 100 runs around the pane, the element 103 forms a continuous inclined funnel, on which the pane is guided while being placed in the frame in such a way as to generate roughly the same gap width 105 between the element 100 and face of the pane, which is subsequently filled with an adhesive material 106.

The insertion element can be hinged to a window part and screwed down. FIGS. 42 and 43 show how an insertion element 110 with a web 11 latches into a back-cut so as to be held fast. Another web 112 facilitates positioning and attachment of the insertion element 110. The insertion element is secured to a respective casement section or window post in order to achieve a simple fixed glazing. The web can here either latch in, or be pushed into a back-cut groove. Another web 113 stabilizes the position of the insertion element in the window component.

Even better thermal damping values are achieved by arranging a trailing gasket 120 between the casement and framework. This gasket can be secured to the casement and framework, and preferably does not act as a stop gasket. FIGS. 44 and 45 show an exemplary embodiment in which the trailing gasket on the door or window frame or a window post is arranged right next to a recess for a closure element. With the window closed, the semicircular gasket is deformed in such a way that a sharp-angled side 121 of the gasket 120 is oriented toward the inner surface of the window, and a bead-like thickened area 122 points to the outer surface of the window.

FIGS. 44 and 45 also show a simplified configuration of a water discharge channel 123. This channel is formed by arranging a foamed strip 126 in the chamber 124 of the hollow chamber profile 125 that does not completely fill the chamber. This creates a channel 123 between the foamed strip 126 and walls of the chamber that can be used to drain off water. To this end, boreholes 128 through the profile wall are provided on the side 127 of the hollow chamber profile 125 facing the casement, through which water can get into the channel 123. The water then flows in the channel toward boreholes 129 underneath the profile, or toward boreholes 130 on the outer surface of the profile.

FIGS. 45 and 46 show various reinforcing strips 140 and 141 for plastic hollow chamber profiles, in particular for door or window frames. These reinforcing strips consist of metal, which has recesses in areas 142, 143 and 144. These recesses are boreholes or regions stamped out of the plane, which limit the flow of heat from the inner surface of the window to the outer surface of the window. The recesses are preferably staggered longitudinal holes that extend in the profile direction, and hence diminish the flow of heat transverse to the profile direction. The profile is angled at both ends, and folded over once or more, depending on static requirements.

Notches 145 and 146 in the plastic hollow chamber profile 125 lie opposite a recess-free area of the reinforcing strip 140, and denote a suitable location for incorporating a threaded joint.

Foamed strips 147 are inserted between the reinforcing strip 140, 141 and the plastic hollow chamber profile. These can be loosely arranged, held as a fit or adhesively bonded with the reinforcing strip. The recess-free area of the reinforcing strip between areas 142 and 143 or next to area 144 is especially suitable for bonding purposes.

1-46. (canceled)

47. A component, in particular windows or doors, with a window casement and a pane, in particular a glass surface, in which the pane has an inner surface and an outer surface, and a plane perpendicular to these surfaces intersects a grooved region designed to receive fittings, and with a door or window frame, against which the pane abuts, wherein the pane intersects this plane, and that the door or window frame covers more than 24 mm, preferably more than 30 mm, glass mounting depth on at least one side of the pane.

48. The component according to claim 47, wherein a hollow chamber is arranged in this plane between the pane and grooved fitting region.

49. The component according to claim 47, wherein, when viewed perpendicular to the sides of the pane, the ratio of viewing width for the window casement relative to glass mounting depth measures under 4, preferably under 3, and especially preferred under 2.

50. The component according to claim 47, wherein, when viewed perpendicular to the sides of the pane, the ratio of viewing width for the window casement to the depth of the window casement measures less than 1, preferably less than 0.9.

51. The component according to claim 47, wherein it exhibits no hollow chamber between the planes of the inner surface and outer surface of the pane.

52. The component according to claim 47, wherein the window casement extends in a plane perpendicular to the sides of the pane at least over a partial depth of the pane edge.

53. The component according to claim 52, wherein the casement extends in the plane perpendicular to the sides of the pane only to the plane of the outer surface of the pane.

54. The component according to claim 47, wherein the pane edge between the sides of the pane is designed as a flat surface.

55. The component according to claim 47, wherein the pane exhibits several individual panes of the same size.

56. The component according to claim 47, wherein a web forms a funnel around the pane for inserting a pane.

57. The component according to claim 56, wherein the web exhibits an incision in the corners of the funnel.

58. The component according to claim 56, wherein the web is secured to a side of the window casement running parallel to the outer surface of the pane.

59. The component according to claim 47, wherein the window casement extends L-shaped around an edge of the pane.

60. The component according to claim 47, wherein it exhibits a cover on the outer surface of the pane.

61. The component according to claim 60, wherein the cover is L-shaped in a section through the planes of the pane.

62. The component according to claim 60, wherein the cover only covers a portion of the glass mounting depth.

63. The component according to claim 60, wherein the cover and window casement interact by way of a spring-groove system.

64. The component according to claim 60, wherein the cover is adhesively bonded with the pane.

65. The component according to claim 47, wherein the window casement has another mount for another pane.

66. The component according to claim 47, wherein the window casement has a plane with a grooved fitting area lying opposite the door or window frame, and exhibits a folding height of about 12 mm in a first area lying opposite the grooved fitting area between the plane and the door or window frame, and the folding height measures less than 12 mm, preferably less than 6 mm, and especially preferred 0 to about 4 mm in a second area between the plane of the window casement and door or window frame.

67. The component according to claim 66, wherein the second area is longer than 30 mm in an alignment perpendicular to the sides of the pane.

68. The component according to claim 66, wherein a gasket against which the pane abuts is arranged in the abutment area of the door or window frame and pane.

69. The component according to claim 47, wherein the window casement and door or window frame cover roughly the same area of the pane.

70. The component according to claim 47, wherein the door or window frame is a single piece opposite the window casement, and exhibits a groove on the surface facing away from the pane.

71. The component according to claim 47, wherein a trailing gasket is arranged between the casement and framework.
